(19) United States
(12) Patent Application Publication
(10) Pub. No.: US 2022/0141371 A1
(43) Pub. Date: May 5, 2022

(54) CONTROL APPARATUSES, PHOTOGRAPHING APPARATUSES, MOVABLE OBJECTS, CONTROL METHODS, AND PROGRAMS

(71) Applicant: SZ DJI TECHNOLOGY CO., LTD., Shenzhen (CN)

(72) Inventors: Kunihiko IETOMI, Shenzhen (CN); Jianbin ZHOU, Shenzhen (CN); Zhejun CHEN, Shenzhen (CN)

(73) Assignee: SZ DJI TECHNOLOGY CO., LTD., Shenzhen (CN)

(21) Appl. No.: 17/524,623

(22) Filed: Nov. 11, 2021

Related U.S. Application Data
(63) Continuation of application No. PCT/CN2020/102917, filed on Jul. 20, 2020.

(30) Foreign Application Priority Data
Jul. 31, 2019 (JP) 2019-141589

(51) Int. Cl. H04N 5/235

(52) U.S. Cl. CPC H04N 5/2353; H04N 5/2354

(57) ABSTRACT

An exposure time may become extremely long due to automatic exposure control. A control apparatus includes a circuit, configured to set an upper limit of an exposure time is provided. The circuit is configured to determine an exposure time of a photographing apparatus within a range below the upper limit according to an exposure control value of the photographing apparatus. A control method includes steps of setting an upper limit of an exposure time is also provided. The control method includes the following step: determining an exposure time of a photographing apparatus within a range below the upper limit according to an exposure control value of the photographing apparatus.

### RELATED APPLICATIONS

This application is a continuation application of PCT application No. PCT/CN2020/102917, filed on Jul. 20, 2020, which claims priority of Japanese application No. JP 2019-141589 filed on Jul. 31, 2019, and the contents of both applications are incorporated herein by reference in their entirety.

### TECHNICAL FIELD

The present disclosure relates to a control apparatus, a photographing apparatus, a movable object, a control method, and a program.

### BACKGROUND

Reference 1 discloses: Determine a changing point for camera sensitivity in a specified program curve chart according to a preset upper limit value or a preset lower limit value of the camera sensitivity.

### PRIOR ART LITERATURE

Reference 1: Japanese Patent Publication No. 2012-19427.

### SUMMARY

### Technical Problem to be Resolved

In existing technologies, during photographing of a relatively dark object, an exposure time may become extremely long due to automatic exposure control. Thus, there is a need to reduce the exposure time.

### Technical Solutions

In some exemplary embodiments, a control apparatus is provided. The control apparatus includes: a circuit, where the circuit is configured to: set an upper limit of an exposure time, and determine an exposure time of a photographing apparatus within a range below the upper limit based on an exposure control value of the photographing apparatus.

In some exemplary embodiments, an apparatus is provided. The apparatus includes: a control apparatus of a photographing apparatus, including: a circuit, where the circuit is configured to: set an upper limit of an exposure time, and determine an exposure time of a photographing apparatus within a range below the upper limit based on an exposure control value of the photographing apparatus.

In some exemplary embodiments, a control method is provided. The control method includes: setting an upper limit of an exposure time of a photographing apparatus; and determine an exposure time of the photographing apparatus within a range below the upper limit based on an exposure control value of the photographing apparatus.

In addition, the above summary does not enumerate all the essential features of the present disclosure. In addition, sub-combinations of these feature groups may also be covered under the present disclosure.

### BRIEF DESCRIPTION OF THE DRAWINGS

To clearly describe the technical solutions in the embodiments of the present disclosure, the following briefly describes the accompanying drawings required for describing the embodiments. Evidently, the accompanying drawings in the following description show merely some exemplary embodiments of the present disclosure, and a person of ordinary skill in the art may still derive other drawings from these accompanying drawings without creative efforts.

FIG. 1 is a diagram showing exteriors of an unmanned aerial vehicle (UAV) 10 and a remote operation apparatus 300 according to some exemplary embodiments of the present disclosure;

FIG. 2 is a diagram showing exteriors of a photographing apparatus 100 mounted on the UAV 10 according to some exemplary embodiments of the present disclosure;

FIG. 3 is a diagram showing function blocks of the UAV 10 according to some exemplary embodiments of the present disclosure;

FIG. 4 is a diagram showing function blocks of the photographing apparatus 100 according to some exemplary embodiments of the present disclosure;

FIG. 5 is a diagram showing a range of a program curve chart generated when a user has set an upper limit of an exposure time according to some exemplary embodiments of the present disclosure;

FIG. 6 is a diagram showing a range of a program curve chart generated when a user has set an upper limit of an exposure time according to some exemplary embodiments of the present disclosure;

FIG. 7 is a diagram showing a user interface to set an upper limit of an exposure time according to some exemplary embodiments of the present disclosure;

FIG. 8 is a diagram showing a user interface to set an upper limit of an exposure time according to some exemplary embodiments of the present disclosure;

FIG. 9 is a flowchart of an execution process of a photographing control unit 182 according to some exemplary embodiments of the present disclosure;

FIG. 10 is a diagram showing exteriors of the photographing apparatus 100 mounted on the UAV 10 according to some exemplary embodiments of the present disclosure; and

FIG. 11 is a diagram showing a hardware composition according to some exemplary embodiments of the present disclosure.

### DETAILED DESCRIPTION

The following describes the present disclosure by using implementations of the disclosure. However, the following implementations do not limit the claims. In addition, all combinations of features described in the implementations may not be necessary for solutions of the disclosure. Evidently, a person of ordinary skill in the art may make various changes or improvements to the following implementations. It is apparent from the description of the claims that such changes or improvements should fall within the technical scope of the present disclosure.

It should be noted that, when a component is described as “fixed” to another component, the component may be directly located on another component, or an intermediate component may exist therebetween. When a component is considered as “connected” to another component, the component may be directly connected to another element, or an intermediate element may exist therebetween.

Unless otherwise defined, meanings of all technical and scientific terms used in the present disclosure are the same as those generally understood by persons skilled in the art of the present disclosure. The terms used in the present disclosure of the present disclosure herein are used only to describe specific embodiments, and not intended to limit the present disclosure. The term “and/or” used in the present disclosure includes any or all possible combinations of one or more associated listed items.

The following describes in detail some implementations of the present disclosure with reference to the accompanying drawings. Under a condition that no conflict occurs, the following embodiments and features in the embodiments may be mutually combined. The following description provides specific application scenarios and requirements of the present application in order to enable those skilled in the art to make and use the present application. Various modifications to the disclosed embodiments will be apparent to those skilled in the art. The general principles defined herein may be applied to other embodiments and applications without departing from the spirit and scope of the disclosure. Therefore, the present disclosure is not limited to the embodiments shown, but the broadest scope consistent with the claims.

The terminology used herein is for the purpose of describing particular exemplary embodiments only and is not intended to be limiting. When used in this disclosure, the terms “comprise”, “comprising”, “include” and/or “including” refer to the presence of stated features, integers, steps, operations, elements, and/or components, but do not preclude the presence or addition of one or more other features, integers, steps, operations, elements, components, and/or groups thereof. As used in this disclosure, the term “A on B” means that A is directly adjacent to B (from above or below), and may also mean that A is indirectly adjacent to B (i.e., there is some element between A and B); the term “A in B” means that A is all in B, or it may also mean that A is partially in B.

In view of the following description, these and other features of the present disclosure, as well as operations and functions of related elements of the structure, and the economic efficiency of the combination and manufacture of the components, may be significantly improved. All of these form part of the present disclosure with reference to the drawings. However, it should be clearly understood that the drawings are only for the purpose of illustration and description, and are not intended to limit the scope of the present disclosure. It is also understood that the drawings are not drawn to scale.

In some embodiments, numbers expressing quantities or properties used to describe or define the embodiments of the present application should be understood as being modified by the terms “about”, “generally”, “approximate,” or “substantially” in some instances. For example, “about”, “generally”, “approximately” or “substantially” may mean a ±20% change in the described value unless otherwise stated. Accordingly, in some embodiments, the numerical parameters set forth in the written description and the appended claims are approximations, which may vary depending upon the desired properties sought to be obtained in a particular embodiment. In some embodiments, numerical parameters should be interpreted in accordance with the value of the parameters and by applying ordinary rounding techniques. Although a number of embodiments of the present application provide a broad range of numerical ranges and parameters that are approximations, the values in the specific examples are as accurate as possible.

Each of the patents, patent applications, patent application publications, and other materials, such as articles, books, instructions, publications, documents, products, etc., cited herein are hereby incorporated by reference, which are applicable to all contents used for all purposes, except for any history of prosecution documents associated therewith, or any identical prosecution document history, which may be inconsistent or conflicting with this document, or any such subject matter that may have a restrictive effect on the broadest scope of the claims associated with this document now or later. For example, if there is any inconsistent or conflicting in descriptions, definitions, and/or use of a term associated with this document and descriptions, definitions, and/or use of the term associated with any materials, the term in this document shall prevail.

It should be understood that the embodiments of the application disclosed herein are merely described to illustrate the principles of the embodiments of the application. Other modified embodiments are also within the scope of this application. Therefore, the embodiments disclosed herein are by way of example only and not limitations. Those skilled in the art may adopt alternative configurations to implement the technical solution in this application in accordance with the embodiments of the present application. Therefore, the embodiments of the present application are not limited to those embodiments that have been precisely described in this disclosure.

The following describes the present disclosure by using implementations of the present disclosure. However, the following implementations do not limit the claims. In addition, all feature combinations described in the implementations are not necessarily mandatory for solutions of the present disclosure. For a person of ordinary skill in the art, various variations or improvements may be made to the following implementations. Obviously, from the descriptions of the claims, any manner of such variations or improvements may be included in the technical scope of the present disclosure.

The claims, the specification, the accompanying drawings, and the abstract may include matters that are subject to copyright protection. The copyright holder will not raise an objection to the facsimile reproduction by anyone of the patent document or the patent disclosure, as it appears in the Patent and Trademark Office patent file or records, but otherwise reserves all copyright rights whatsoever.

Various implementations of the present disclosure may be described with reference to flowcharts and block diagrams. Herein, a block may indicate (1) a stage of a process for performing an operation or (2) a “unit” of an apparatus having a function of performing an operation. The specified stage and “unit” may be implemented by a programmable circuit and/or a processor. A dedicated circuit may include a digital and/or analog hardware circuit and may include integrated circuit (IC) and/or a discrete circuit. The programmable circuit may include a reconfigurable hardware circuit. The reconfigurable hardware circuit may include logic AND, logic OR, logic XOR, logic NAND, logic NOR, and other logic operations, and storage elements such as a trigger, a register, a field programmable gate array (FPGA), a programmable logic array (PLA).

A computer-readable medium may include any tangible device that may store at least one instruction executable by an appropriate device. As a result, the computer-readable medium storing at least one instruction may include a product including at least one instruction executable to create means for performing operations specified by the flowcharts or block diagrams. An example of the computer-readable medium may include but not limited to an electronic storage medium, a magnetic storage medium, an optical storage medium, an electromagnetic storage medium, a semiconductor storage medium, and the like. A specific example of the computer-readable medium may include a Floppy™ disk, a diskette, a hard disk, a random-access memory (RAM), a read-only memory (ROM), an erasable programmable ROM (EPROM or flash memory), an electrically erasable programmable ROM (EEPROM), a static RAM (SRAM), a compact disc ROM (CD-ROM), a digital versatile disc (DVD), a Blu-ray® disc, a memory stick, an integrated circuit card, or the like.

At least one computer-readable instruction may include any one of source code or object code described by any combination of one or more programming languages. The source code or the object code may include a conventional program-mode programming language. The conventional program-mode programming language may be an object-oriented programming language and the “C” programming language or a similar programming language, for example, an assembly instruction, an instruction set architecture (ISA) instruction, a machine instruction, a machine-related instruction, a microcode, a firmware instruction, status setting data, or Smalltalk™, JAVA™, or C++. The computer-readable instruction may be provided locally or through a local area network (LAN), a wide area network (WAN) such as the Internet to a processor or a programmable circuit of a general-purpose computer, a dedicated computer, or another programmable data processing apparatus. The processor or the programmable circuit may execute the at least one computer readable instruction to create a means for performing the operations specified by the flowcharts or the block diagrams. A non-limiting example of the processor may include a computer processor, a processing unit, a microprocessor, a digital signal processor, a controller, a microcontroller, or the like.

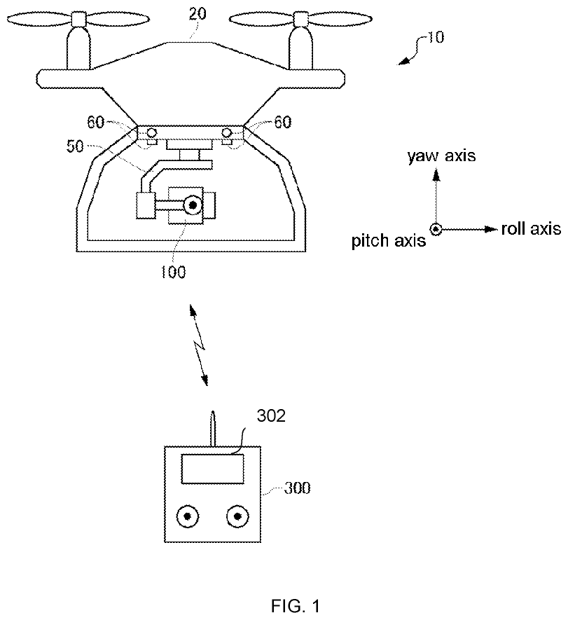

FIG. 1 is a diagram showing exteriors of a UAV 10 and a remote operation apparatus 300 according to some exemplary embodiments of the present disclosure. The UAV 10 may include a UAV main body 20, a universal joint 50, a plurality of photographing devices 60, and a photographing apparatus 100. The universal joint 50 and the photographing apparatus 100 may be an example of a photographing system. The UAV 10 may be an example of a movable object. The movable object may include a flying object movable in the air, a vehicle movable on the ground, a ship movable on the water, or the like. The flying object movable in the air may include not only a UAV, but also other concepts such as an aircraft, an airship, and a helicopter movable in the air.

The UAV main body 20 may include a plurality of propellers. The plurality of propellers may be an example of a propulsion unit. The UAV main body 20 may enable the UAV 10 to fly by controlling the plurality of propellers to rotate. The UAV main body 20 may use, for example, four propellers to enable the UAV 10 to fly. A quantity of the propellers may not be limited to four. In addition, the UAV 10 may alternatively be a fixed-wing aircraft without any propellers.

The photographing apparatus 100 may be a multispectral camera for photographing objects in a desired photographing range in each waveband of a plurality of wavebands. The universal joint 50 may rotatably support the photographing apparatus 100. The universal joint 50 may be an example of a support mechanism. For example, the universal joint 50 may support the photographing apparatus 100 by using an actuator to rotate around a pitch axis. The universal joint 50 may support the photographing apparatus 100 so that the photographing apparatus 100 may further rotate around a roll axis and a yaw axis respectively by using the actuator. The universal joint 50 may change an attitude of the photographing apparatus 100 by causing the photographing apparatus 100 to rotate around at least one of the yaw axis, the pitch axis, or the roll axis.

The plurality of photographing devices 60 may be cameras for sensing and photographing surroundings of the UAV 10 to control the flight of the UAV 10. Two photographing devices 60 may be arranged on a nose, that is, a front side of the UAV 10. In addition, the other two photographing devices 60 may be arranged on a bottom side of the UAV 10. The two photographing devices 60 on the front side may be paired to function as a stereoscopic camera. The two photographing devices 60 on the bottom side may also be paired to function as a stereoscopic camera. The photographing device 60 may detect existence of an object within a photographing range of the photographing device 60 and may measure a distance to the object. The photographing device 60 may be an example of a measurement apparatus that measures an object existing in a photographing direction of the photographing apparatus 100. The measurement apparatus may alternatively be another sensor such as an infrared sensor or an ultrasonic sensor that measures an object existing in a photographing direction of the photographing apparatus 100. Three-dimensional space data around the UAV 10 may be generated based on images obtained by the plurality of photographing devices 60. A quantity of photographing apparatuses 60 of the UAV 10 may not be limited to four. In some exemplary embodiments, the UAV 10 may include at least one photographing device 60. In some exemplary embodiments, the UAV 10 may include at least one photographing device 60 on each of the nose, a tail, a side surface, the bottom surface, and a top surface of the UAV 10. A viewing angle settable in the photographing device 60 may be greater than a viewing angle settable in the photographing apparatus 100. The photographing device 60 may also include a single focus lens or a fisheye lens.

The remote operation apparatus 300 may communicate with the UAV 10 to remotely operate the UAV 10. The remote operation apparatus 300 may wirelessly communicate with the UAV 10. The remote operation apparatus 300 may send, to the UAV 10, indication information of various instructions related to movements of the UAV 10 such as ascending, descending, accelerating, decelerating, moving forward, moving backward, or rotating. The indication information may include, for example, indication information causing the UAV 10 to ascend. The indication information may indicate a height at which the UAV 10 should be located. The UAV 10 may move to a height indicated by the indication information received from the remote operation apparatus 300. The indication information may include an ascending instruction to raise the UAV 10. The UAV 10 may ascend after receiving the ascending instruction. When the height of the UAV 10 has reached an upper height limit, ascending of the UAV 10 may be limited even if the ascending instruction is received.

The remote operation apparatus 300 may include a display apparatus 302. The display apparatus 302 may display an image obtained by the photographing apparatus 100. In addition, the display apparatus 302 may further function as an input apparatus to receive information input by a user so as to remotely operate the UAV 10. For example, the display apparatus 302 may receive setting information of the photographing apparatus 100. The remote operation apparatus 300 may send to the UAV 10, based on the setting information received from the user, indication information indicating various instructions related to actions of the photographing apparatus 100.

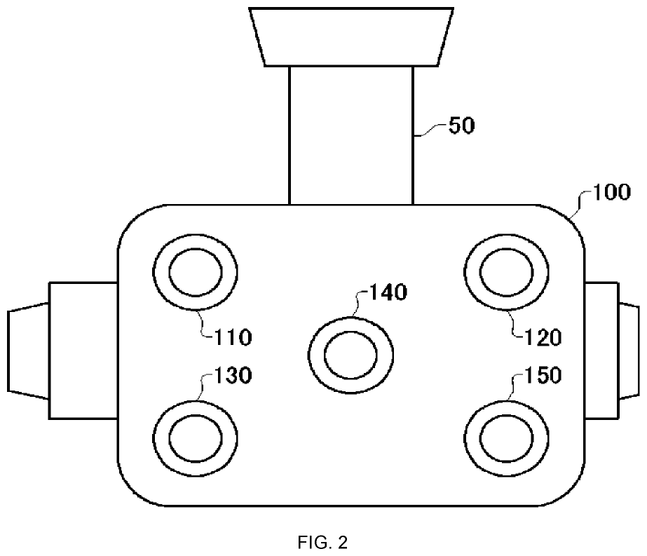

FIG. 2 is a diagram showing exteriors of the photographing apparatus 100 mounted on the UAV 10 according to some exemplary embodiments of the present disclosure. The photographing apparatus 100 may be a multispectral camera for obtaining image data of each of a plurality of preset wavebands. The photographing apparatus 100 may include an R photographing apparatus 110, a G photographing apparatus 120, a B photographing apparatus 130, an RE photographing apparatus 140, and an NIR photographing apparatus 150. The photographing apparatus 100 may record respective image data obtained by the R photographing apparatus 110, the G photographing apparatus 120, the B photographing apparatus 130, the RE photographing apparatus 140, and the NIR photographing apparatus 150 as a multispectral image. For example, the multispectral image may be used to predict health statuses and vitality of crops.

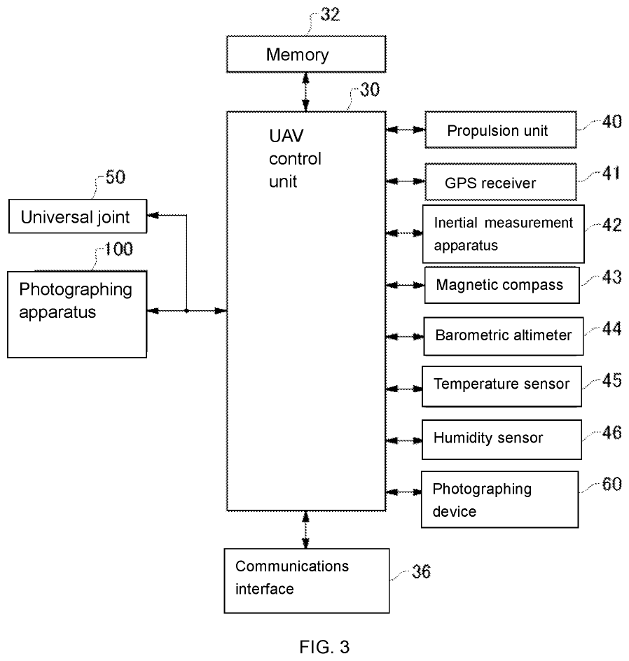

FIG. 3 is a diagram showing function blocks of the UAV 10 according to some exemplary embodiments of the present disclosure. The UAV 10 may include a UAV control unit 30, a memory 32, a communications interface 36, a propulsion unit 40, a GPS receiver 41, an inertial measurement apparatus (IMU) 42, a magnetic compass 43, a barometric altimeter 44, a temperature sensor 45, a humidity sensor 46, a universal joint 50, a photographing device 60, and a photographing apparatus 100.

The communications interface 36 may communicate with another apparatus such as the remote operation apparatus 300. The communications interface 36 may receive, from the remote operation apparatus 300, indication information including various instructions for the UAV control unit 30. The memory 32 may store programs and the like required by the UAV control unit 30 to control the propulsion portion 40, the GPS receiver 41, the IMU 42, the magnetic compass 43, the barometric altimeter 44, the temperature sensor 45, the humidity sensor 46, the universal joint 50, the photographing device 60, and the photographing apparatus 100. The memory 32 may be a computer-readable recording medium, and may include at least one of flash memories such as an SRAM, a DRAM, an EPROM, an EEPROM, or a USB memory. The memory 32 may be disposed inside the UAV main body 20. The memory 32 may be detachably disposed on the UAV main body 20.

The UAV control unit 30 may control the flight and photographing of the UAV 10 based on the program stored in the memory 32. The UAV control unit 30 may include a microprocessor such as a CPU or an MPU, and a microcontroller such as an MCU. The UAV control portion 30 may control the flight and photographing of the UAV 10 in accordance with instructions received from the remote operation apparatus 300 through the communications interface 36. The propulsion portion 40 may propel the UAV 10. The propulsion portion 40 may include a plurality of propellers and a plurality of drive motors causing the plurality of propellers to rotate. The propulsion portion 40 may cause the UAV 10 to fly by causing the plurality of rotors to rotate through the plurality of drive motors according to an instruction from the UAV control unit 30.

The GPS receiver 41 may receive a plurality of time signals sent from a plurality of GPS satellites. The GPS receiver 41 may calculate, based on the plurality of received signals, a position (e.g., latitude and longitude) of the GPS receiver 41, that is, a position (latitude and longitude) of the UAV 10. The IMU 42 may detect an attitude of the UAV 10. The IMU 42 may detect acceleration of the UAV 10 in front-back, left-right, and up-down, and angular velocities in tri-axial directions of a pitch axis, a roll axis, and a yaw axis, and use them as the attitude of the UAV 10. The magnetic compass 43 may detect an orientation of the nose of the UAV 10. The barometric altimeter 44 may detect a flight height by detecting air pressure around the UAV 10, and converting the detected air pressure to the flight height. The temperature sensor 45 may detect a temperature around the UAV 10. The humidity sensor 46 may detect humidity around the UAV 10.

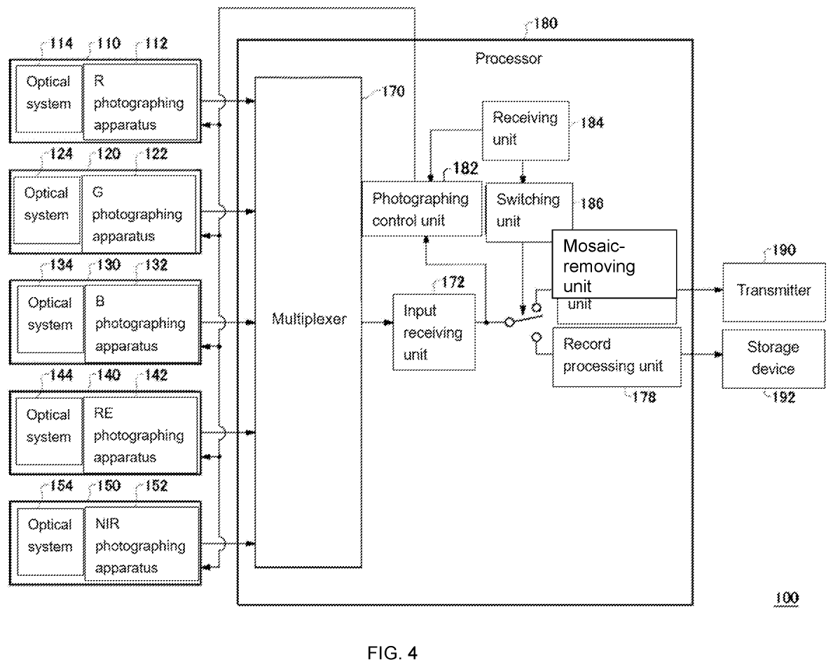

FIG. 4 is a diagram showing function blocks of the photographing apparatus 100 according to some exemplary embodiments of the present disclosure. The photographing apparatus 100 may include an R photographing apparatus 110, a G photographing apparatus 120, a B photographing apparatus 130, an RE photographing apparatus 140, and an NIR-specific photographing apparatus 150. The photographing apparatus 100 may include a processor 180, a transmitter 190, and a storage device 192.

The R photographing apparatus 110 may include an R image sensor 112 and an optical system 114. The R image sensor 112 may obtain an image formed by the optical system 114. The R image sensor 112 may include a filter that allows light with a wavelength in the red region to pass through, and may output an image signal (i.e., an R image signal) with the wavelength in the red region. For example, the wavelength in the red region may be from 620 nm to 750 nm. The wavelength in the red region may be a specific wavelength in the red region, for example, from 663 nm to 673 nm.

The G photographing apparatus 120 may include a G image sensor 122 and an optical system 124. The G image sensor 122 may obtain an image formed by the optical system 124. The G image sensor 122 may include a filter that allows light with a wavelength in the green region to pass through, and may output an image signal (i.e., a G image signal) with the wavelength in the green region. For example, the wavelength in the green region may be from 500 nm to 570 nm. The wavelength in the green region may be a specific wavelength in the green region, for example, from 550 nm to 570 nm.

The B photographing apparatus 130 may include a B image sensor 132 and an optical system 134. The B image sensor 132 may obtain an image formed by the optical system 134. The B image sensor 132 may include a filter that allows light with a wavelength in the blue region to pass through, and may output an image signal (i.e., a B image signal) with the wavelength in the blue region. For example, the wavelength in the blue region may be from 450 nm to 500 nm. The wavelength in the blue region may be a specific waveband in the blue region, for example, from 465 nm to 485 nm.

The RE photographing apparatus 140 may include an RE image sensor 142 and an optical system 144. The RE image sensor 142 may obtain an image formed by the optical system 144. The RE image sensor 142 may include a filter that allows light with a wavelength in the red edge region to pass through, and may output an image signal (i.e., an RE image signal) with the wavelength in the red edge region. For example, the wavelength in the red edge region may be from 705 nm to 745 nm. The wavelength in the red edge region may be 712 nm to 722 nm.

The NIR photographing apparatus 150 may include an NIR image sensor 152 and an optical system 154. The NIR image sensor 152 may obtain an image formed by the optical system 154. The NIR image sensor 152 may include a filter that allows light with a wavelength in the near infrared region to pass through, and may output an image signal (i.e., an NIR image signal) with the wavelength in the near infrared region. For example, the wavelength in the near infrared region may be from 800 nm to 2500 nm. The wavelength in the near infrared region may be from 800 nm to 900 nm.

The processor 180 may include a multiplexer 170, an input receiving unit 172, a mosaic-removing unit 174, and a record processing unit 178. The processor 180 may be an example of a circuit. The processor 180 may include a microprocessor such as a CPU or an MPU, and a microcontroller such as an MCU.

The multiplexer 170 may receive an image signal output from each image sensor, and may select, according to a preset condition, an image signal output from any image sensor, and inputs the image signal in the input receiving unit 172.

The mosaic-removing unit 174 may generate image data for display according to the R image signal, the G image signal, and the B image signal input into the input receiving unit 172. The mosaic-removing unit 174 may perform mosaic removal processing on the R image signal, the G image signal, and the B image signal, to generate the image data for display. The mosaic-removing unit 174 may perform sparse processing on the R image signal, the G image signal, and the B image signal, and convert the sparse processed R image signal, the sparse processed G image signal, and the sparse processed B image signal into Bayer array image signals, to generate the image data for display. The transmitter 190 may send the image data for display to the display apparatus. For example, the transmitter 190 may send the image data for display to the remote operation apparatus 300. The remote operation apparatus 300 may display the image data for display on the display apparatus 302, as a real-time framing image.

The record processing unit 178 may generate image data for recording based on the R image signal, the G image signal, the B image signal, the RE image signal, and the NIR image signal that are input into the input receiving unit 172, as well as a preset recording format. The record processing unit 178 may generate RAW data, according to a RAW format, by using the R image signal, the G image signal, the B image signal, the RE image signal, and the NIR image signal, and use the RAW data as the image data for recording. The record processing unit 178 may generate full-pixel image data for recording without separately performing sparse processing on the R image signal, the G image signal, the B image signal, the RE image signal, and the NIR image signal. The record processing unit 178 may store the image data for recording in the storage device 192. The storage device 192 may be a computer-readable recording medium, or may include at least one of flash memories such as an SRAM, a DRAM, an EPROM, an EEPROM, or a USB memory. The storage device 192 may be disposed inside a housing of the photographing apparatus 100. The storage device 192 may be detachably disposed on the housing of the photographing apparatus 100.

The processor 180 may further include a receiving unit 184 and a switching unit 186. The receiving portion 184 may receive a storage instruction on storing the image data for recording into the storage device 192. The receiving unit 184 may receive a storage instruction from a user through an external terminal such as the remote operation apparatus 300. When the photographing apparatus 100 is in a predetermined position, the receiving unit 184 may receive the storage instruction from the UAV control unit 30. When the UAV 10 is in the predetermined position, the UAV control portion 30 may determine that the position of the photographing apparatus 100 is the predetermined position, and the receiving unit 184 may receive the storage instruction from the UAV control unit 30. The photographing apparatus 100 may include a GPS receiver. In this case, the processor 180 may determine, according to position information from the GPS receiver of the processor 180, whether the photographing apparatus 100 is in the preset position. The switching unit 186 may switch between the following two manners. The first manner is to generate image data for display in the mosaic-removing unit 174 according to the R image signal, the G image signal, and the B image signal that are input into the input receiving unit 172. The second manner is to generate image data for recording in the record processing unit 178 in a preset recording format according to the R image signal, the G image signal, the B image signal, the RE image signal, and the NIR image signal that are input into the input receiving unit 172.

Exposure control in the photographing apparatus 100 is described below. The photographing control unit 182 may set an upper limit of an exposure time (a charge accumulation time of the image sensor). The photographing control unit 182 may determine an exposure time of the photographing apparatus 100 within a range below the upper limit according to an exposure control value of the photographing apparatus 100. The photographing control unit 182 may set an upper limit based on an upper limit input value.

The photographing control unit 182 may cause the display apparatus 302 to display information for inputting the upper limit and an exposure time determined within the range below the upper limit according to a current exposure control value of the photographing apparatus 100. After setting the upper limit, the photographing control unit 182 may update the exposure time displayed on the display apparatus 302 when the photographing apparatus 100 is in operation.

When the upper limit is not set, the photographing control unit 182 may determine the exposure time based on the exposure control value within a range equal to or less than a preset value longer than the maximum value of the upper limit value that can be input by the user.

When the upper limit is set, the photographing control unit 182 may generate a program curve chart within the range below the upper limit. The program curve chart may show a relationship of an exposure value, camera sensitivity, and an exposure time. The photographing control unit 182 may determine the exposure time and the camera sensitivity according to the exposure control value and the program curve chart.

The photographing control unit 182 may determine, according to the exposure control value, the exposure time in a range below the upper limit when camera sensitivity is fixed to a preset value. When the exposure time obtained when the camera sensitivity is fixed to the preset value may not be determined within the range below the upper limit, the photographing control unit 182 may determine the exposure time as the upper limit, and determines, according to the exposure control value, the camera sensitivity obtained when the exposure time is the upper limit. For example, when the photographing control unit 182 determines that underexposure will occur when the camera sensitivity is the preset value and the exposure time is set to the upper limit, the photographing control unit 182 may further increases the camera sensitivity according to the exposure control value while keeping the exposure time at the upper limit.

The photographing apparatus 100 may include a first photographing apparatus that performs photographing with light in a first wavelength region and a second photographing apparatus that performs photographing with light in a second wavelength region. The photographing control unit 182 may determine, within the range below the upper limit, an exposure time of the first photographing apparatus and an exposure time of the second photographing apparatus. For example, the upper limit may include a first upper limit of an exposure time of the light in the first wavelength region and a second upper limit of an exposure time of the light in the second wavelength region. The photographing control unit 182 may determine the exposure time of the first photographing apparatus within the first upper limit according to an exposure control value corresponding to the light in the first wavelength region. The photographing control unit 182 may determine the exposure time of the second photographing apparatus within the second upper limit according to an exposure control value corresponding to the light in the second wavelength region. In addition, the first photographing apparatus may be any one of: the R photographing apparatus 110, the G photographing apparatus 120, the B photographing apparatus 130, the RE photographing apparatus 140, and the NIR photographing apparatus 150, and the second photographing apparatus may be any one of the other photographing apparatuses in the R photographing apparatus 110, the G photographing apparatus 120, the B photographing apparatus 130, the RE photographing apparatus 140, and the NIR photographing apparatus 150. That is, the first photographing apparatus may be different from the second photographing apparatus.

The photographing apparatus 100 may have a fixed aperture. For example, the R photographing apparatus 110, the G photographing apparatus 120, the B photographing apparatus 130, the RE photographing apparatus 140, and the NIR photographing apparatus 150 each may have a fixed aperture.

The photographing control unit 182 may set the upper limit based on a moving speed of the photographing apparatus 100. For example, the photographing control unit 182 may set the upper limit according to a moving speed of the UAV 10. The photographing control unit 182 may set the upper limit according to a relative speed between the UAV 10 and a subject.

The photographing control unit 182 may set the upper limit according to a direction changing speed of the photographing apparatus 100. The photographing control unit 182 may set the upper limit according to a rotating speed of the universal joint 50 of the photographing apparatus 100.

The photographing control unit 182 may determine the exposure time within the range below the upper limit according to the exposure control value when an aperture of the photographing apparatus 100 is fixed. The photographing control unit 182 may determine an F value and an exposure time according to the exposure control value when the aperture of the photographing apparatus 100 is not fixed. In addition, “when the aperture of the photographing apparatus 100 is fixed” may include but not limited to the following cases: the photographing apparatus 100 may be a photographing apparatus with a variable aperture and a photographing mode may be set to an aperture priority mode. “When the aperture of the photographing apparatus 100 is fixed” may include but not limited to the following cases: the photographing apparatus 100 may be a photographing apparatus with a variable aperture, and underexposure occurs when the F value is set to a minimum value. That is, the aperture corresponds to the F value. When the aperture (i.e., the F value) is fixed (i.e., set to the minimum value), the photographing control unit changes the exposure time to obtain a suitable light amount. In this case, the light amount is already determined based on the determined exposure time within the range below the upper limit. Thus, underexposure will occur. “When the aperture of the photographing apparatus 100 is fixed”, may include but not limited to the following cases: the photographing apparatus 100 may include no aperture. That the photographing apparatus 100 includes no aperture may be equivalent to the case in which the photographing apparatus 100 includes a fixed aperture.

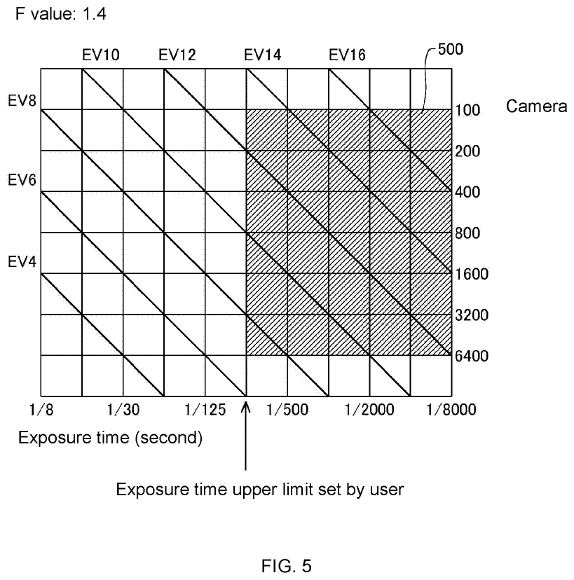

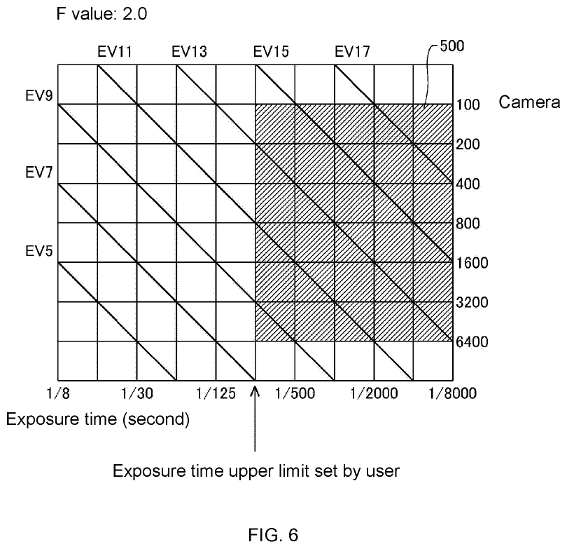

FIG. 5 and FIG. 6 each is a diagram showing a range of a program curve chart generated when a user sets an upper limit of an exposure time according to some exemplary embodiments of the present disclosure. The R photographing apparatus 110 is used as a non-limiting example for description herein. The R photographing apparatus 110 may include a function of changing the exposure time within a range of 1/8000 second to ⅛ second. The R photographing apparatus 110 may include a function of changing ISO sensitivity within a range from 100 to 6400. FIG. 5 is a diagram showing a case in which the F value is 1.4. FIG. 6 is a diagram showing a case in which the F value is 2.0. 1/8000 second may not be the shortest time of the exposure time. For example, the shortest time may be 1/20000 second.

The x-axis in each of FIG. 5 and FIG. 6 indicates the exposure time, and the y-axis indicates the camera sensitivity. The shaded area 500 shown in each of FIG. 5 and FIG. 6 may indicate a range of a program curve chart generated by the photographing control unit 182 when the upper limit of the exposure time is set to 1/250 second.

In a case of automatic exposure control, the photographing control unit 182 may determine the exposure control value according to an image obtained by the R photographing apparatus 110. For example, the photographing control unit 182 may determine an exposure value (EV) value based on brightness information of the image obtained by the R photographing apparatus 110.

The photographing control unit 182 may determine the exposure time and the camera sensitivity according to a program curve chart generated within the shaded area 500 based on an upper limit of the exposure time and the EV value. As described above, the photographing control unit 182 may not set the exposure time to be greater than 1/250 second in the R photographing apparatus 110. In other words, the photographing control unit 182 may prohibit the R photographing apparatus 110 from being exposed for an exposure time greater than 1/250 second.

In addition, a maximum value of the upper limit of the exposure time that may be set by a user in the R photographing apparatus 110 may be less than ⅛ second. For example, the maximum value of the upper limit of the exposure time that may be set by the user may be 1/15 second. When the upper limit of the exposure time is not set by the user, the photographing control unit 182 may determine the exposure time within a range below the maximum value, namely, ⅛ second, of the exposure time that may be set in the R photographing apparatus 110. In other words, when the upper limit of the exposure time is not set by the user, the photographing control unit 182 may determine an exposure time greater than 1/15 second.

The photographing control unit 182 may set respective exposure times and camera sensitivities of the G photographing apparatus 120, the B photographing apparatus 130, the RE photographing apparatus 140, and the NIR photographing apparatus 150 respectively by using a method that is the same as the method for setting the exposure time and the camera sensitivity in the R photographing apparatus 110. In other words, the photographing control unit 182 may generate, within the range below the preset upper limit of the exposure time, a program curve chart for each of the G photographing apparatus 120, the B photographing apparatus 130, the RE photographing apparatus 140, and the NIR photographing apparatus 150. In addition, the photographing control unit 182 may determine the EV value based on brightness information of an image obtained by each of the G photographing apparatus 120, the B photographing apparatus 130, the RE photographing apparatus 140, and the NIR photographing apparatus 150, and determines the exposure time and the camera sensitivity of each photographing apparatus according to the generated program curve chart and the EV value.

In addition, the photographing control unit 182 may determine respective EV values of the R photographing apparatus 110, the G photographing apparatus 120, the B photographing apparatus 130, the RE photographing apparatus 140, and the NIR photographing apparatus 150 based on brightness information of a specific region in each of the R photographing apparatus 110, the G photographing apparatus 120, the B photographing apparatus 130, the RE photographing apparatus 140, and the NIR photographing apparatus 150. The specific region may be, for example, a region including a same to-be-photographed subject. The photographing control unit 182 may calculate a vegetation index for each pixel according to the image information of the specific region in each of the R photographing apparatus 110, the G photographing apparatus 120, the B photographing apparatus 130, the RE photographing apparatus 140, and the NIR photographing apparatus 150, and may determine an image region where vegetation index meets a preset condition as the specific region. In addition, the vegetation index may show a normalized difference vegetation index (NDVI), a solid adjusted vegetation index (SAVI), a green normalized difference vegetation index (gNDVI), or a normalized difference red edge index (NDRE), or the like.

In addition, when the user sets the upper limit of the exposure time, the photographing control unit 182 may determine, according to the EV value and the camera sensitivity, an exposure time for proper exposure within range below the upper limit set by the user, while fixing the camera sensitivity to the preset value (for example, ISO sensitivity 100). When underexposure will occur even when the exposure time is the upper limit, the photographing control unit 182 may determine an appropriate camera sensitivity for proper exposure according to the EV value and the upper limit of the exposure time, when the exposure time is the user set upper limit. Underexposure becomes more common when photographing is performed in a relatively dark environment. In this case, the photographing control unit 182 may not change the exposure time, so that the exposure time may exceed the set upper limit of the exposure time. Instead of not changing the exposure time, the photographing control unit 182 may improve exposure by increasing a gain applied to an image sensor of each of the R photographing apparatus 110, the G photographing apparatus 120, the B photographing apparatus 130, the RE photographing apparatus 140, and the NIR photographing apparatus 150. In addition, the photographing control unit 182 may keep the gain applied to the image sensor at a specified value (for example, the gain is 1.0). The photographing control unit 182 may only increase the gain when the exposure may not be adjusted without increasing the gain. This may prevent quality deterioration of a picture obtained by the image sensor. The ISO sensitivity may be sensitivity to specific light. Therefore, adjusting the gain may be equivalent to adjusting the ISO sensitivity.

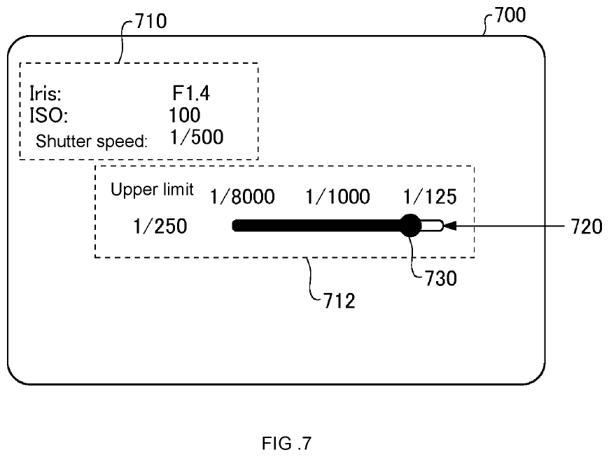

FIG. 7 is a diagram showing a under interface 700 to set an upper limit of an exposure time according to some exemplary embodiments of the present disclosure. The user interface 700 may be displayed on the display apparatus 302. The user interface 700 may be a user interface obtained when respective photographing apparatuses of the R photographing apparatus 110, the G photographing apparatus 120, the B photographing apparatus 130, the RE photographing apparatus 140, and the NIR photographing apparatus 150 are collectively controlled. The user interface 700 may include a display region 710 of exposure conditions and a setting region 712 for setting an upper limit of an exposure time.

The display region 710 may display an aperture value (Iris), camera sensitivity (ISO), and an exposure time (shutter speed) in the photographing apparatus 100. The setting region 712 may display a slider bar 720 for receiving a change to the upper limit of the exposure time.

The slider bar 720 may be a means used by a user to enter the upper limit of the exposure time. The user may move a button (marker) 730 of the slider bar 720 to change the upper limit of the exposure time. As shown in FIG. 7, the user interface 700 indicates a state in which the upper limit of the exposure time is set to 1/250 second. The remote operation apparatus 300 may send, to the UAV 10, indication information indicating an upper limit of an exposure time specified by a user. The photographing control unit 182 may determine an exposure time and camera sensitivity below an upper limit of an exposure time indicated by the indication information received by using the UAV control portion 30. The transmitter 190 may send exposure conditions including an aperture value of the photographing apparatus 100, a determined exposure time, and the camera sensitivity to the remote operation apparatus 300. The remote operation apparatus 300 may update the user interface 700 according to the received exposure conditions.

In this way, the remote operation apparatus 300 may prompt the user of a current exposure condition in the photographing apparatus 100. The user may operate the button 730 of the slider bar 720 to change the upper limit, so that the exposure time and the camera sensitivity may be changed. For example, when the user changes the upper limit of the exposure time from the state shown in FIG. 7 to 1/1000 second, assuming that the EV value is fixed, the photographing control unit 182 may set the exposure time to 1/1000 second, and may change the camera sensitivity (ISO sensitivity) to 200 for proper exposure. The shutter speed (exposure time) displayed in the display region 710 may be updated in real time. For example, when the button 730 of the slider bar 720 is moved to set the upper limit of the exposure time to 1/1000 second, the shutter speed displayed in the display region 710 may be 1/2000 second or 1/10000 second depending on an exposure condition. In this case, the gain is kept at, for example, 1.0. In some exemplary embodiments, the underexposure becomes more common and the shutter speed may not be adjusted. In this case, the gain may be greater than 1.0. Information about the gain may be displayed together with information about the ISO sensitivity on the display portion 710. The gain adjusting may be replaced by other methods to adjust the ISO sensitivity in the same way as the gain adjusting. In some exemplary embodiments, when the ISO 500 is set to a specified value and the underexposure becomes more common, ISO 800, which is greater than the ISO 500, may be set. In this way, deterioration of picture quality may be minimized. After the upper limit of the exposure time is set, the ISO sensitivity, the gain, and the shutter speed may be updated in real time (sequentially) when the photographing apparatus 100 is in operation. In this way, the user may obtain a photographing status in real time. In some exemplary embodiments, the shutter speed of the display portion 710 may be replaced with the slider bar 720. In this case, when an upper limit of the shutter speed is set, the shutter speed may be switched in real time thereafter.

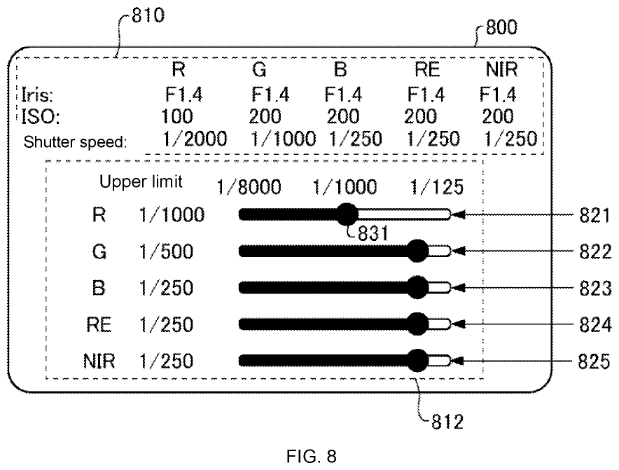

FIG. 8 is a diagram showing a user interface to set an upper limit of an exposure time according to some exemplary embodiments of the present disclosure. The user interface 800 may be displayed on the display apparatus 302. The user interface 800 may be the user interface used to separately control the R photographing apparatus 110, the G photographing apparatus 120, the B photographing apparatus 130, the RE photographing apparatus 140, and the NIR photographing apparatus 150. The user interface 800 may include a display region 810 indicting exposure conditions and a setting region 812 for setting an upper limit of the exposure time.

The display region 810 may display respective aperture values (Iris), camera sensitivity (ISO), and exposure times (shutter speeds) of the R-photographing apparatus 110, the G photographing apparatus 120, the B photographing apparatus 130, the RE photographing apparatus 140, and the NIR photographing apparatus 150. The setting region 812 may display slider bars 821, 822, 823, 824, and 825. The slider bars 821, 822, 823, 824, and 825 are each an exemplary means for receiving information about a change in the upper limit of the exposure time of the R photographing apparatus 110, the G photographing apparatus 120, the B photographing apparatus 130, the RE photographing apparatus 140, and the NIR photographing apparatus 150.

The user may move a button 831 of the slider bar 821 to change the upper limit of the exposure time of the R photographing apparatus 110. Similarly, the user may move positions of respective buttons of the slider bars 822 to 825, to change the upper limits of the respective exposure times of the G photographing apparatus 120, the B photographing apparatus 130, the RE photographing apparatus 140, and the NIR photographing apparatus 150 one by one.

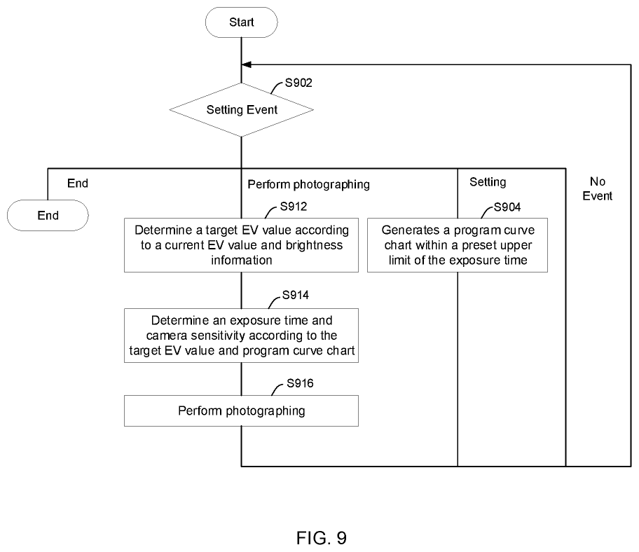

FIG. 9 is a flowchart of an execution process of a photographing control unit 182 according to some exemplary embodiments of the present disclosure. In S902, the photographing control unit 182 may determine an event type related to an exposure condition. In some exemplary embodiments, the event may include a setting event for an upper limit of an exposure time, a photographing event, and a photographing ending event. The setting event for the upper limit of the exposure time may occur when a user changes an upper limit of the exposure time by using the remote operation apparatus 300. The photographing event may occur when the user uses the remote operation apparatus 300 to instruct photographing. The photographing end event may occur when the user uses the remote operation apparatus 300 to indicate that photographing ends.

In S902, when the setting event for the upper limit of the exposure time occurs, in S904, the photographing control unit 182 generates a program curve chart within a preset upper limit of the exposure time. The photographing apparatus 182 may generate a program curve chart of each of the R photographing apparatus 110, the G photographing apparatus 120, the B photographing apparatus 130, the RE photographing apparatus 140, and the NIR photographing apparatus 150.

When the photographing event occurs in S902, in S912, the photographing control unit 182 may determine a target EV value according to a current EV value and brightness information of an image obtained by the photographing apparatus 100. Specifically, the photographing control unit 182 may determine an EV value of each of the R photographing apparatus 110, the G photographing apparatus 120, the B photographing apparatus 130, the RE photographing apparatus 140, and the NIR photographing apparatus 150.

In S914, an exposure time and camera sensitivity may be determined according to the program curve chart generated in S904 and the EV value determined in S912. The photographing control unit 182 may determine the exposure time and the camera sensitivity of each of the R photographing apparatus 110, the G photographing apparatus 120, the B photographing apparatus 130, the RE photographing apparatus 140, and the NIR photographing apparatus 150.

In S916, the photographing control unit 182 may cause, according to the exposure times and the camera sensitivity determined in S914, the R photographing apparatus 110, the G photographing apparatus 120, the B photographing apparatus 130, the RE photographing apparatus 140, and the NIR photographing apparatus 150 to perform photographing.

When the end event occurs in S902, end processing of the flowchart.

As described above, based on the settable upper limit of the exposure time of photographing apparatus 100, an extremely long exposure time in automatic exposure control may be suppressed. In this way, image blur and extreme overexposure may also be suppressed. For example, even if the UAV 10 is flying at a high speed while photographing crops on the ground, the exposure time may be set to remain unchanged so as to reduce image blur of the crops. A health condition and the like of the crops may be better analyzed. In addition, an upper limit of an exposure time of each wavelength region of light of a photographed subject may be set based on the photographing apparatus 100. For example, there may be large differences between intensity of R components and intensity of G components in places where crops have been harvested and places where crops have not been harvested. Even in this case, by adjusting the upper limit of the exposure time of each wavelength region of the light of the photographed subject, photographing in an overexposed state may be suppressed.

Exposure processing described corresponding to the foregoing implementation may be applicable to a photographing apparatus with a fixed aperture and with no variable aperture. Through the foregoing exposure processing, a plurality of relatively simple photographing apparatuses with no variable apertures may be used, so that the photographing apparatus 100 may be constructed with low costs. The exposure processing described corresponding to the foregoing exemplary embodiments may also be applicable to a single photographing apparatus.

In addition, the foregoing exemplary embodiments mainly disclose the case in which the user sets the upper limit of the exposure time. However, the upper limit of the exposure time may alternatively be set by the photographing control unit 182 according to a moving speed of the photographing apparatus 100. For example, as the moving speed of the photographing apparatus 100 increases, the photographing control unit 182 may determine a smaller value as the upper limit of the exposure time. In addition, the photographing control unit 182 may set the upper limit according to a relative speed between the UAV 10 and a subject. In addition, the photographing control unit 182 may set the upper limit according to a direction changing speed of the photographing apparatus 100. The photographing control unit 182 may set the upper limit according to a rotating speed of the universal joint 50 of photographing apparatus 100. As the rotating speed of the universal joint 50 of the photographing apparatus 100 increases, the photographing control portion 182 may determine a smaller value as the upper limit of the exposure time.

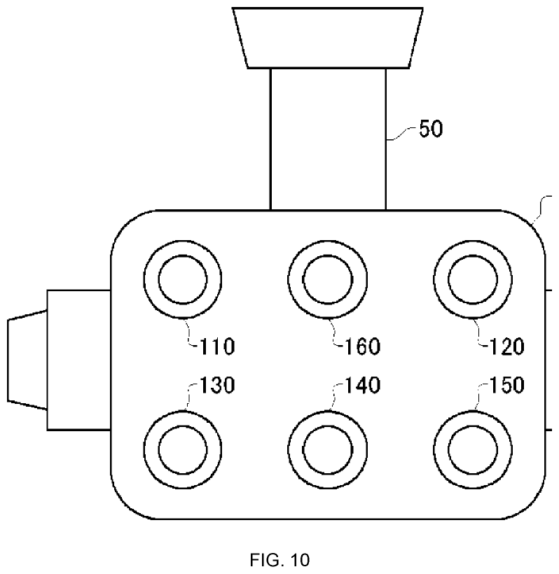

FIG. 10 is a diagram showing exteriors of the photographing apparatus 100 mounted on the UAV 10 according to some exemplary embodiments of the present disclosure. In addition to the R photographing apparatus 110, the G photographing apparatus 120, the B photographing apparatus 130, the RE photographing apparatus 140, and the NIR photographing apparatus 150, the photographing apparatus 100 may further include an RGB photographing apparatus 160. This is different from the photographing apparatus 100 shown in FIG. 2. The RGB photographing apparatus 160 may be the same as a general camera, and may include an optical system and an image sensor. The image sensor may include a filter that includes a Bayer array and that allows light with a wavelength in a red region to pass through, a filter that allows light with a wavelength in a green region to pass through, and a filter that allows light with a wavelength in a blue region to pass through. The RGB-specific photographing apparatus 160 may output an RGB image. For example, the wavelength in the red region may be from 620 nm to 750 nm. For example, the wavelength in the green region may be from 500 nm to 570 nm. For example, the wavelength in the blue region may be from 450 nm to 500 nm.

The photographing control unit 182 may generate a program curve chart for a range below an upper limit of an exposure time of the RGB photographing apparatus 160 in a manner that is the same as exposure control of the R photographing apparatus 110, the G photographing apparatus 120, the B photographing apparatus 130, the RE photographing apparatus 140, and the NIR photographing apparatus 150, and may determine the exposure time and camera sensitivity according to the program curve chart and an EV value.

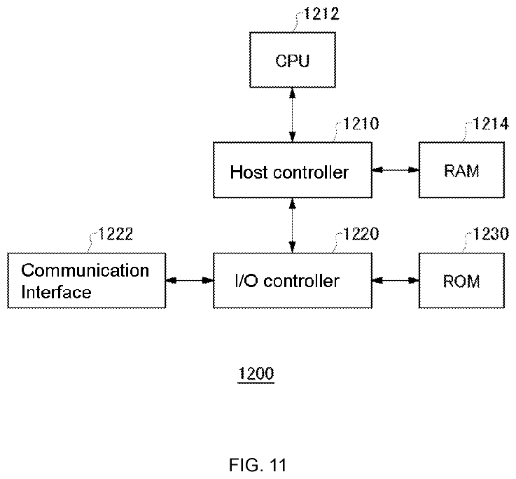

FIG. 11 is a diagram showing a computer 1200 that may reflect a plurality of manners of the present disclosure completely or partially according to some exemplary embodiments of the present disclosure. A program installed in the computer 1200 may enable the computer 1200 to function as an operation associated with the apparatus related in the implementations of the present disclosure or one or more “units” of the apparatus. Alternatively, the program may enable the computer 1200 to perform the operation or the one or more “units”. The program may enable the computer 1200 to perform the process in the implementations of the present disclosure or a stage of the process. Such a program may be executed by the CPU 1212, to enable the computer 1200 to perform specified operations associated with some or all of the blocks in the flowcharts and the block diagrams described in this specification.

In some exemplary embodiments of the present disclosure, the computer 1200 may include a CPU 1212 and a RAM 1214, which may be connected to each other through a host controller 1210. The computer 1200 may further include a communications interface 1222 and an input/output unit, which may be connected to the host controller 1210 through an input/output controller 1220. The computer 1200 may further include a ROM 1230. The CPU 1212 may operate according to programs stored in the ROM 1230 and the RAM 1214 to control each unit.

The communications interface 1222 may communicate with another electronic apparatus through a network. A hard disk drive may store programs and data that are used by the CPU 1212 in the computer 1200. The ROM 1230 may store a boot program executable by the computer 1200 during operation, and/or a program that depends on hardware of the computer 1200. The programs may be provided through a computer readable recording medium such as a CR-ROM, a USB memory, or an IC card, or a network. The programs may be installed in the RAM 1214 or the ROM 1230 that also functions as a computer readable recording medium, and may be executed by the CPU 1212. Information processing recorded in these programs may be read by the computer 1200, and may cause cooperation between the programs and the foregoing various types of hardware resources. An information operation or processing may be implemented based on use of the computer 1200 to constitute an apparatus or a method.

For example, when the computer 1200 communicates with an external apparatus, the CPU 1212 may execute a communication program loaded in the RAM 1214, and command, based on processing described in the communication program, the communications interface 1222 to perform communication processing. Under the control of the CPU 1212, the communications interface 1222 may read and send data stored in a send buffer provided by a recording medium such as the RAM 1214 or a USB memory, and may send the read sent data to a network, or may write received data received from the network into a receiving buffer provided by the recording medium, or the like.

In addition, the CPU 1212 may enable the RAM 1214 to read all or a required part of files or databases stored in an external recording medium such as a USB memory, and may perform various types of processing on the data on the RAM 1214. Then, the CPU 1212 may write the processed data back to the external recording medium.

Various types of information such as various types of programs, data, tables, and databases may be stored in the recording medium, for information processing. For data read from the RAM 1214, the CPU 1212 may perform various types of processing such as various types of operations specified by an instruction sequence of the program, information processing, conditional judgement, conditional transfer, unconditional transfer, and information retrieval/replacement, which may be described throughout the present disclosure, and write results back into the RAM 1214. In addition, the CPU 1212 may retrieve information from a file, a database, or the like within the recording medium. For example, when the recording medium stores a plurality of entries having an attribute value of a first attribute respectively associated with an attribute value of a second attribute, the CPU 1212 may retrieve, from the plurality of entries, an entry matching a condition of the attribute value of the first attribute, and may read the attribute value of the second attribute stored in the entry, thereby obtaining the attribute value of the second attribute associated with the first attribute meeting a predetermined condition.

The forgoing program or software module may be stored in the computer 1200 or in a computer readable storage medium near the computer 1200. In addition, a recording medium such as a hard disk or a RAM provided in a server system connected to a dedicated communication network or the Internet may be used as a computer readable storage medium, so that the programs may be provided for the computer 1200 through the network.

It should be noted that an execution order of various types of processing such as the action, sequence, step, and stage of the apparatus, system, program, and method in the claims, specification, and accompanying drawings may be implemented in any order, provided that there is no special statement such as “before . . . ” or “in advance”, and an output of previous processing is not used in subsequent processing. For the operation procedure in the claims, specification, and accompanying drawings, “first” and “next” and the like are used for ease of description, but it does not mean that an implementation must be implemented in such an order.

The present disclosure is described above by using the implementations. However, the technical scope of the present disclosure is not limited to the scope described in the foregoing implementations. For a person of ordinary skill in the art may make various changes or improvements to the implementations. It is apparent from the description of the claims that all manners of such changes or improvements may be included within the technical scope of the present disclosure.

### REFERENCE NUMERALS

10 UAV
20 UAV main body
30 UAV control unit
32 Memory
36 Communications interface
40 Propulsion unit
41 GPS receiver
42 Inertial measurement apparatus
43 Magnetic compass
44 Barometric altimeter
45 Temperature sensor
46 Humidity sensor
50 Universal joint
60 Photographing device
100 Photographing apparatus
110 R photographing apparatus
112 R image sensor
114 Optical system
120 G photographing apparatus
122 G image sensor
124 Optical system
130 B photographing apparatus
132 B image sensor
134 Optical system
140 RE photographing apparatus
142 RE image sensor
144 Optical system
150 NIR photographing apparatus
152 NIR image sensor
154 Optical system
160 RGB photographing apparatus
170 Multiplexer
172 Input receiving unit
174 Mosaic-removing unit
178 Record processing unit
180 Processor
182 Photographing control unit
184 Receiving unit
186 Switching unit
190 Transmitter
192 Storage device
300 Remote operation apparatus
302 Display apparatus
500 Range
700, 800 User interface
710, 810 Display region
712, 812 Setting region
720 Slider bar
730, 831 Button
821, 822, 823, 824, 825 Slider bar
1200 Computer
1210 Host controller
1212 CPU
1214 RAM
1220 Input/Output controller
1222 Communications interface
1230 ROM

What is claimed is:

1. A control apparatus, comprising:
a circuit, wherein the circuit is configured to:
set an upper limit of an exposure time, and
determine an exposure time of a photographing apparatus within a range below the upper limit based on an exposure control value of the photographing apparatus.

2. The control apparatus according to claim 1, wherein the circuit is configured to set the upper limit inputted to the circuit.

3. The control apparatus according to claim 2, wherein the circuit is configured to:
display, on a display apparatus, information of the inputted upper limit and the exposure time.

4. The control apparatus according to claim 3, wherein the circuit is configured to:
update the exposure time displayed on the display apparatus after setting the upper limit and when the photographing apparatus is in operation.

5. The control apparatus according to claim 2, wherein the circuit is configured to:
when the upper limit is not set, determine the exposure time based on the exposure control value within a range less than a preset value longer than the maximum value of the upper limit inputtable by a user.

6. The control apparatus according to claim 1, wherein the circuit is configured to:
generate a program curve chart showing a relationship of an exposure value, camera sensitivity, and an exposure time within the range below the upper limit when the upper limit is set; and
determine the exposure time and the camera sensitivity based on the exposure control value and the program curve chart.

7. The control apparatus according to claim 1, wherein the circuit is configured to:
determine, based on the exposure control value and within the range below the upper limit, the exposure time when camera sensitivity is fixed to a preset value.

8. The control apparatus according to claim 1, wherein when unable to determine, within the range below the upper limit, the exposure time when camera sensitivity is fixed to a preset value, the circuit is configured to
determine the exposure time to be the upper limit; and
determine, based on the exposure control value, camera sensitivity when the exposure time is fixed to the upper limit.

9. The control apparatus according to claim 1, wherein the photographing apparatus includes a fixed aperture.

10. The control apparatus according to claim 1, wherein the photographing apparatus includes:
a first photographing apparatus performing photographing with light in a first wavelength region and a second photographing apparatus performing photographing with light in a second wavelength region,
wherein the circuit is configured to determine, within the upper limit, a first photographing apparatus exposure time and a second photographing apparatus exposure time.

11. The control apparatus according to claim 10, wherein
the upper limit includes:
a first upper limit of an exposure time of the light in the first wavelength region and a second upper limit of an exposure time of the light in the second wavelength region;
the circuit is configured to:
determine the first photographing apparatus exposure time within the range below the first upper limit based on an exposure control value corresponding to the light in the first wavelength region; and
determine the second photographing apparatus exposure time within a range below the second upper limit based on an exposure control value corresponding to the light in the second wavelength region.

12. The control apparatus according to claim 1, wherein the circuit is configured to set the upper limit based on a moving speed of the photographing apparatus.

13. The control apparatus according to claim 1, wherein the circuit is configured to set the upper limit based on a direction changing speed of the photographing apparatus.

14. The control apparatus according to claim 1, wherein the circuit is configured to:
determine the exposure time within the range below the upper limit based on the exposure control value when an aperture of the photographing apparatus is fixed; or
determine an F value and the exposure time according to the exposure control value when the aperture of the photographing apparatus is not fixed.

15. An apparatus, comprising:
a control apparatus of a photographing apparatus, including:
a circuit, wherein the circuit is configured to:
set an upper limit of an exposure time, and
determine an exposure time of a photographing apparatus within a range below the upper limit based on an exposure control value of the photographing apparatus.

16. The apparatus according to claim 15, wherein the circuit is configured to set the upper limit inputted to the circuit.

17. The apparatus according to claim 16, wherein the circuit is configured to:
display, on a display apparatus, information of the inputted upper limit and the exposure time.

18. The apparatus according to claim 17, wherein the circuit is configured to:
update the exposure time displayed on the display apparatus after setting the upper limit and when the photographing apparatus is in operation.

19. The apparatus according to claim 15, further comprising:
a movable platform, wherein the photographing apparatus is mounted on the movable platform.

20. A control method, comprising:
setting an upper limit of an exposure time of a photographing apparatus; and
determine an exposure time of the photographing apparatus within a range below the upper limit based on an exposure control value of the photographing apparatus.
